(19) United States
(12) Patent Application Publication
(10) Pub. No.: US 2016/0202084 A1
(43) Pub. Date: Jul. 14, 2016

(54) MEASUREMENT DEVICE

(71) Applicants: Nen-Tsua Li, Taichung City (TW); Chen-Yu Liao, Taichung City (TW); Chia-Ching Chen, Taichung City (TW)

(72) Inventors: Nen-Tsua Li, Taichung City (TW); Chen-Yu Liao, Taichung City (TW); Chia-Ching Chen, Taichung City (TW)

(21) Appl. No.: 14/596,196

(22) Filed: Jan. 13, 2015

(51) Int. Cl. G01D 5/12

(52) U.S. Cl. CPC G01D 5/12

(57) ABSTRACT

A measurement device includes a movable member 1, an angle-detection unit 2 and a rotary unit 3. The rotary unit 3 has a shaft 31, a roller 32 and a magnetic disk 33, all of which are connected along a common axis. The outer periphery of the roller 32 rolls along the movable member 1 when the movable member 1 is pulled. There is a gap formed between the angle-detection unit 2 and the magnetic disk 33 which is located corresponding to the center of the angle-detection unit 2 so that the angle-detection unit 2 detects the angular change of the magnetic disk 33 and precisely calculates the distance that the movable member 1 moves.

### BACKGROUND OF THE INVENTION

1. Fields of the invention

The present invention relates to a measurement device, and more particularly, to a measurement device which detects the angular change of a magnetic disk to precisely measure distances.

2. Descriptions of Related Art

The conventional measurement device such as the measurement tapes generally comprises a housing with a mandrel located therein, a tape is scrolled to the mandrel so that the tape can be pulled out from the housing to measure the length of an object or to measure a distance between two points. A stop/release button is located on the housing to stop or release the tape. The user is acknowledged the distance or size by checking the scales on the tape.

However, the tape is narrow and the scales are marked closely so that when using the measurement tape in an area with less illumination, the scales are difficult to be read. Furthermore, the scales on the tape can be worn out after frequent use, and this also cause incorrect reading to the scales.

The present invention intends to provide a measurement device that is designed to eliminate the shortcomings mentioned above.

### SUMMARY OF THE INVENTION

The present invention relates to a measurement device and comprises a movable member, an angle-detection unit and a rotary unit. The rotary unit has a shaft, a roller and a magnetic disk, all of which are connected along a common axis. The outer periphery of the roller rolls along the movable member when the movable member is pulled. There is a gap formed between the angle-detection unit and the magnetic disk which is located corresponding to the center of the angle-detection unit so that the angle-detection unit detects the angular change of the magnetic disk and precisely calculates the distance that the movable member moves. The distance is displayed on the screen of the housing.

Preferably, the angle-detection unit is a Magnetic Resistance Sensor.

Alternatively, the present invention provides another measurement device and comprises an angle-detection unit and a rotary unit. The rotary unit has a shaft, a roller and a magnetic disk, all of which are connected along a common axis. The outer periphery of the roller rolls along the floor or the ground. There is a gap formed between the angle-detection unit and the magnetic disk which is located corresponding to the center of the angle-detection unit so that the angle-detection unit detects the angular change of the magnetic disk and precisely calculates the distance that the roller moves. The distance is displayed on the screen of the housing.

Preferably, the measurement device includes a housing, and a handle extends from the housing. The angle-detection unit and the magnetic disk are located in the housing. The shaft has one end extending through the housing and the roller is located outside of the housing.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the measurement device of the present invention;

FIG. 2 is a perspective view to show that the movable member of the present invention is pulled;

FIG. 3 shows that the angle-detection unit detects the changes of the x-axis and the y-axis of the magnetic disk;

FIG. 4 is a perspective view to show the measurement device of the present invention, and

FIG. 5 is a perspective view to show the second embodiment of the measurement device of the present invention.

### DETAILED DESCRIPTION OF THE PREFERRED EMBODIMENT

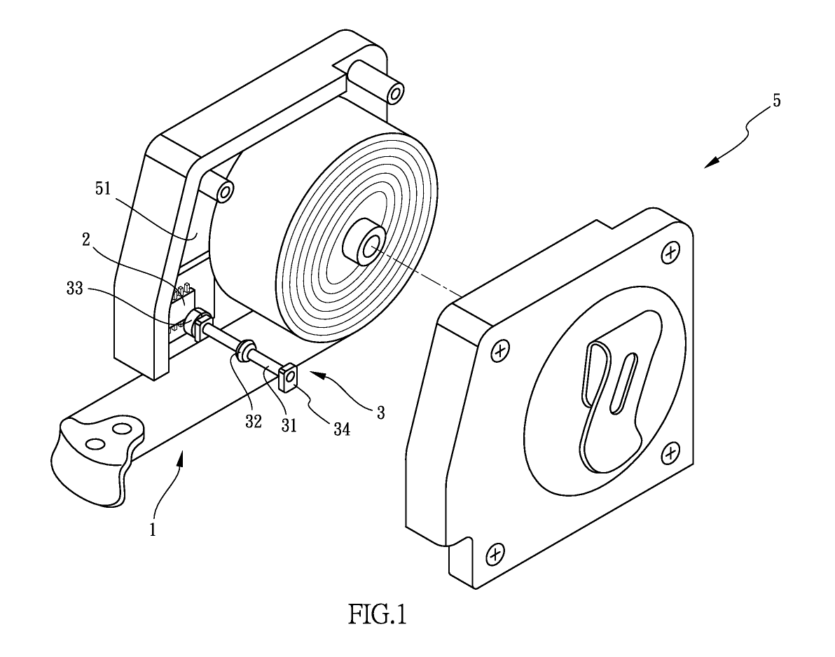

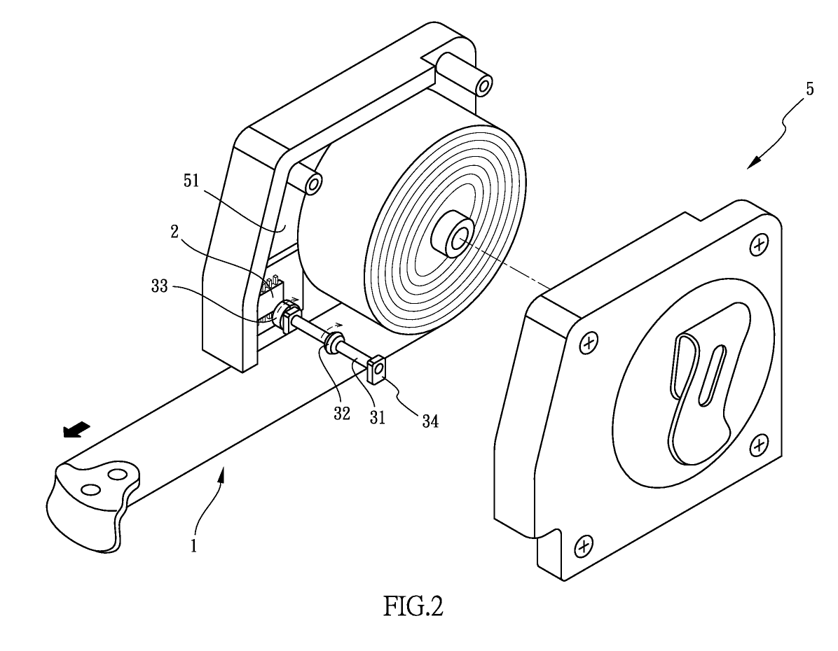

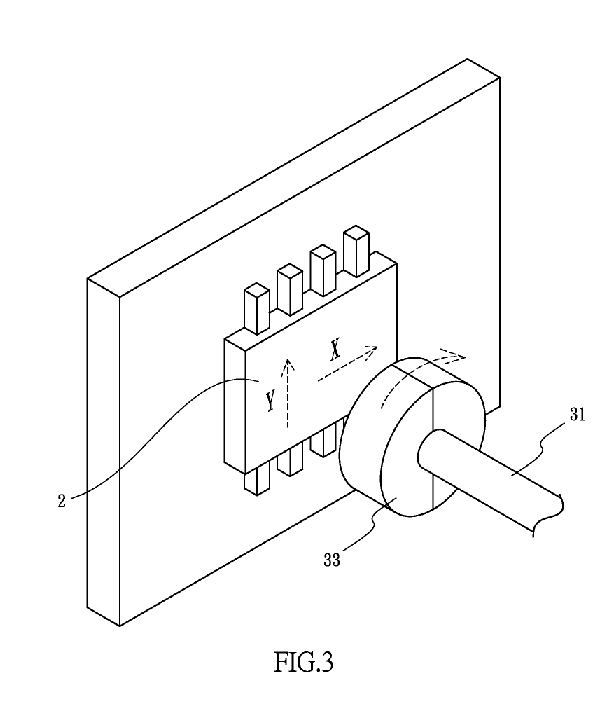

Referring to FIGS. 1 to 3, the measurement device of the present invention comprises a movable member 1, an angle-detection unit 2 and a rotary unit 3. The rotary unit 3 has a shaft 31, a roller 32 and a magnetic disk 33, wherein the shaft 31, the roller 32 and the magnetic disk 33 are all connected along a common axis. The outer periphery of the roller 32 rolls along the movable member 1 when the movable member 1 is pulled. A gap is formed between the angle-detection unit 2 and the magnetic disk 33 which is located corresponding to the center of the angle-detection unit 2. The angle-detection unit 2 detects the angular change of the magnetic disk 33.

When the magnetic disk 33 is rotated, the angle-detection unit 2 detects the change of the magnetic disk 33 in the x-axis and the y-axis so as to obtain the angles that the magnetic disk 33 rotates. The angle that the magnetic disk 33 rotates can be calculated and transformed into the displacement of the roller 32. The roller 32 is rotated by the movement of the movable member 1 so that the distance that the movable member 1 moves is expressed by the equation: D=(θ/360)L, wherein D is the distance that the movable member 1 moves, θ is the angle that the magnetic disk 33 rotates, and L is the circumference of the roller 32. The result of D does not depend on the reading of the user and can be precisely calculated.

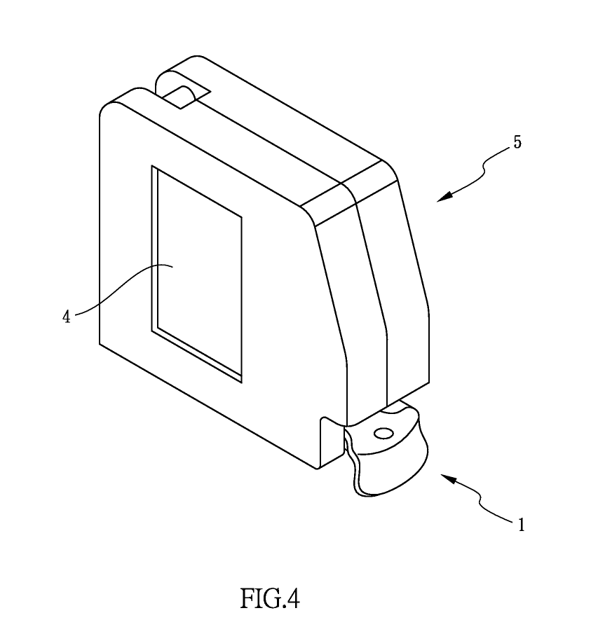

As shown in FIGS. 1 to 4, the embodiment of the measurement device of the present invention is a measurement tape, the movable member 1 is a measurement tape. The embodiment further has a housing 5 which has a screen 4 connected to the housing 5. The screen 4 is electrically connected to the angle-detection unit 2. The housing 5 has a space 51 defined therein and the movable member 1 is scrolled in the space 51, wherein one end of the movable member 1 extends out from an opening of the housing 5. A bearing 34 is located in the space 51 and mounted to the shaft 31. The angle-detection unit 2 is located on the inside of the housing 5. In this embodiment, the angle-detection unit 2 is a Magnetic Resistance

Sensor (MR-Sensor). The angle-detection unit 2 detects the change of the magnetic disk 33 in the x-axis and the y-axis so as to obtain the angles that the magnetic disk 33 rotates. The angle that the magnetic disk 33 rotates can be calculated and transformed into the displacement of the movable member 1.

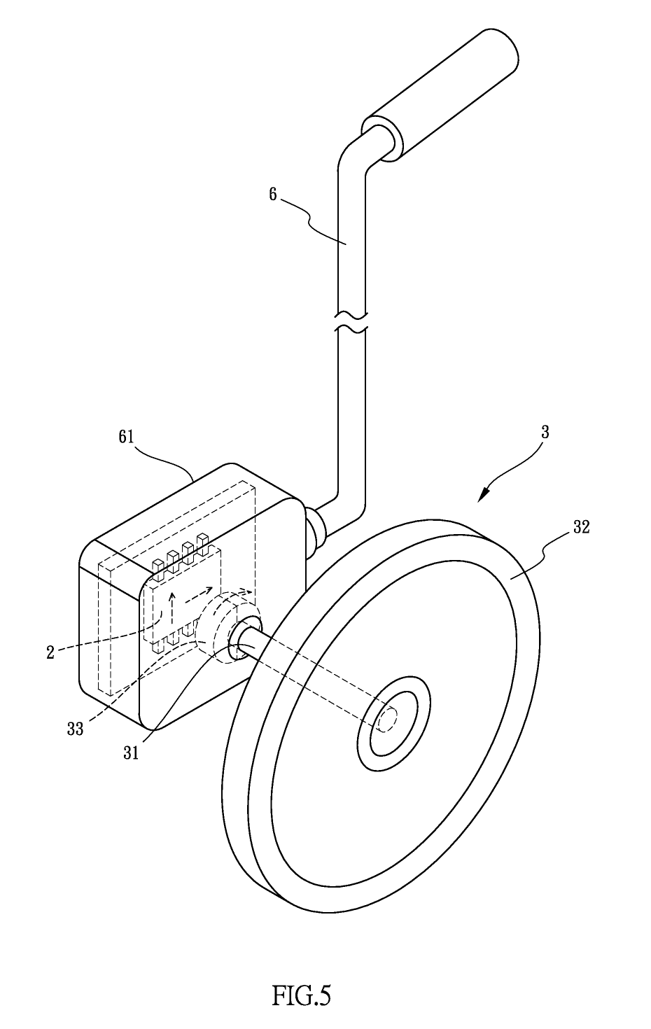

FIG. 5 shows the second embodiment of the measurement device of the present invention, and comprises an angle-detection unit 2 and a rotary unit 3. The rotary unit 3 has a shaft 31, a roller 32 and a magnetic disk 33, wherein the shaft 31, the roller 32 and the magnetic disk 33 are connected along a common axis. The outer periphery of the roller 32 can roll along a floor or ground. A gap is formed between the angle-detection unit 2 and the magnetic disk 33 which is located corresponding to the center of the angle-detection unit 2. The angle-detection unit 2 detects the angular change of the magnetic disk 33. By the detected angular change of the magnetic disk 33, the number of revolutions of the roller 32 rolls can be obtain, and the distance that the roller 32 travels can be calculated by multiplication of the circumference of the roller 32 and the times of revolutions.

The measurement device further comprises a housing 6, and a handle 61 extends from the housing 6. The angle-detection unit 2 and the magnetic disk 33 are located in the housing 6, and the shaft 31 has one end extending through the housing 6. The roller 32 is located outside of the housing 6. The user can hold the handle 61 to move the measurement device to measure the distance that the roller 32 travels.

While we have shown and described the embodiment in accordance with the present invention, it should be clear to those skilled in the art that further embodiments may be made without departing from the scope of the present invention.

What is claimed is:

1. A measurement device comprising:
a movable member (1), an angle-detection unit (2) and a rotary unit (3), the rotary unit (3) having a shaft (31), a roller (32) and a magnetic disk (33), the shaft (31), the roller (32) and the magnetic disk (33) being connected along a common axis, an outer periphery of the roller (32) rolling along the movable member (1), a gap formed between the angle-detection unit (2) and the magnetic disk (33) which is located corresponding to a center of the angle-detection unit (2), the angle-detection unit (2) detecting an angular change of the magnetic disk (33).

2. The measurement device as claimed in claim 1 further comprising a housing (5) which has a screen (4) connected to the housing (5), the screen (4) is electrically connected to the angle-detection unit (2), the housing (5) has a space (51) defined therein and the movable member (1) is scrolled in the space (51), one end of the movable member (1) extends out from an opening of the housing (5), a bearing (34) is located in the space (51) and mounted to the shaft (31), the angle-detection unit (2) is located on an inside of the housing (5).

3. The measurement device as claimed in claim 2, wherein the angle-detection unit (2) is a Magnetic Resistance Sensor.

4. A measurement device comprising:
an angle-detection unit (2) and a rotary unit (3), the rotary unit (3) having a shaft (31), a roller (32) and a magnetic disk (33), the shaft (31), the roller (32) and the magnetic disk (33) being connected along a common axis, an outer periphery of the roller (32) adapted to roll along a floor/ground, a gap formed between the angle-detection unit (2) and the magnetic disk (33) which is located corresponding to a center of the angle-detection unit (2), the angle-detection unit (2) detecting an angular change of the magnetic disk (33).

5. The measurement device as claimed in claim 4 further comprising a housing (6), a handle (61) extends from the housing (6), the angle-detection unit (2) and the magnetic disk (33) are located in the housing (6), the shaft (31) has one end extending through the housing (6) and the roller (32) is located outside of the housing (6).
